(19) United States
(12) Patent Application Publication
(10) Pub. No.: US 2026/0080904 A1
(43) Pub. Date: Mar. 19, 2026

(54) TEMPLATE PROCESSING METHOD AND APPARATUS, DEVICE, COMPUTER-READABLE STORAGE MEDIUM, AND PRODUCT

(71) Applicant: Beijing Zitiao Network Technology Co., Ltd., Beijing (CN)

(72) Inventors: Jinjin Wang, Beijing (CN); Yuqing Wang, Beijing (CN); Peng Wang, Beijing (CN); Jinkai Wang, Beijing (CN)

(21) Appl. No.: 19/315,297

(22) Filed: Aug. 29, 2025

(30) Foreign Application Priority Data
Sep. 13, 2024 (CN) 202411289111.9

(51) Int. Cl. G11B 27/031; G06V 20/40

(52) U.S. Cl. CPC G11B 27/031; G06V 20/41; G06V 20/46

(57) ABSTRACT

Embodiments of the present disclosure provide a template processing method and apparatus, a device, a computer-readable storage medium, and a product. The method includes: obtaining a first video generated based on a preset template and a first material; generating a second video based on the preset template and a second material, where a material complexity of the second material is less than a material complexity of the first material; determining at least one time range corresponding to highlight content in the first video and the second video; determining template quality of the preset template based on the at least one time range and a template generation protocol corresponding to the preset template; and pushing the preset template to a target user group in response to the template quality of the preset template satisfying a preset pushing condition.

### CROSS-REFERENCE TO RELATED APPLICATION(S)

This application claims priority to Chinese Application No. 202411289111.9 filed on Sep. 13, 2024, the disclosure of which is incorporated herein by reference in its entirety.

### FIELD

Embodiments of the present disclosure relate to the technical field of data processing, and in particular, to a template processing method and apparatus, a device, a computer-readable storage medium, and a product.

### BACKGROUND

In the related art, a user can generate a video template in a preset application according to an actual need. The video template can include a video processing element such as an effect, a filter, and a transition. After the video template is generated, the user can generate a first video based on the video template and a first material. The first video carries an anchor point of the video template. The first video is posted. Thus, another user can generate an video by using the video template based on the video template anchor point carried in the first video.

However, at present, before the video template is posted, only information check is usually performed on the video template, without detecting template quality of the video template. Therefore, another user may not be able to subsequently generate, based on the video template, video content with an effect similar to the first video.

### SUMMARY

Embodiments of the present disclosure provide a template processing method and apparatus, a device, a computer-readable storage medium, and a product.

In a first aspect, an embodiment of the present disclosure provides a template processing method, including:
obtaining a first video generated based on a preset template and a first material;
generating a second video based on the preset template and a second material, where a material complexity of the second material is less than a material complexity of the first material;
determining at least one time range corresponding to highlight content in the first video and the second video based on the first video and the second video;
determining template quality of the preset template based on the at least one time range and a template generation protocol corresponding to the preset template, where the template generation protocol includes at least one video processing element associated with the preset template and a time range associated with the at least one video processing element; and
pushing the preset template to a target user group in response to the template quality of the preset template satisfying a preset pushing condition.

In a second aspect, an embodiment of the present disclosure provides a template processing apparatus, including:
an obtaining module configured to obtain a first video generated based on a preset template and a first material;
a generation module configured to generate a second video based on the preset template and a second material, where a material complexity of the second material is less than a material complexity of the first material;
a determining module configured to determine at least one time range corresponding to highlight content in the first video and the second video based on the first video and the second video;
a processing module configured to determine template quality of the preset template based on the at least one time range and a template generation protocol corresponding to the preset template, where the template generation protocol includes at least one video processing element associated with the preset template and a time range associated with the at least one video processing element; and
a pushing module configured to push the preset template to a target user group in response to the template quality of the preset template satisfying a preset pushing condition.

In a third aspect, an embodiment of the present disclosure provides an electronic device, including: a processor and a memory.

The memory stores computer-executable instructions.

The processor executes the computer-executable instructions stored in the memory, to cause the at least one processor to perform the template processing method in the first aspect and in various possible designs of the first aspect.

In a fourth aspect, an embodiment of the present disclosure provides a computer-readable storage medium storing computer-executable instructions. The computer-executable instructions, when executed by a processor, implement the template processing method in the first aspect and in various possible designs of the first aspect.

In a fifth aspect, an embodiment of the present disclosure provides a computer program product, including computer programs. The computer programs, when executed by a processor, implement the template processing method in the first aspect and in various possible designs of the first aspect.

### BRIEF DESCRIPTION OF THE DRAWINGS

In order to describe the technical solutions in the embodiments of the present disclosure or in the prior art more clearly, the following briefly introduces the accompanying drawings for describing the embodiments or the prior art. Apparently, the accompanying drawings in the following description show merely some embodiments of the present disclosure, and a person of ordinary skill in the art may still derive other drawings from the accompanying drawings without creative efforts.

FIG. 1 is a schematic flowchart of a template processing method according to an embodiment of the present disclosure;

FIG. 2 is a schematic diagram of an application scene according to an embodiment of the present disclosure;

FIG. 3 is a schematic flowchart of a template processing method according to another embodiment of the present disclosure;

FIG. 4 is a schematic diagram of a first video according to an embodiment of the present disclosure;

FIG. 5 is a schematic flowchart of a template processing method according to another embodiment of the present disclosure;

FIG. 6 is a schematic structural diagram of a template processing apparatus according to an embodiment of the present disclosure; and

FIG. 7 is a schematic structural diagram of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to that an active request of a user has been received, the prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

To solve the technical problem of a monotonous mode for allocating video templates, the present disclosure provides a template processing method and apparatus, a device, a computer-readable storage medium, and a product.

It should be noted that the template processing method and apparatus, the device, the computer-readable storage medium, and the product which are provided in the present disclosure can be applied to any video template quality verification scene.

A user can generate a video template in a preset application according to an actual need. The video template can include a video processing element such as an effect, a filter, and a transition. After the video template is generated, the user can post a first video that is generated based on the video template and a first material. The first video carries the video template.

In the related art, before the video template is posted, generally, only information check is performed on the video template, without detecting template quality of the video template. Since a visual effect presented by the first video is comprehensively determined by the video template and the first material, quality of video template content cannot be accurately detected based on a video effect of the first video. Therefore, after the video template is posted, another user may not be able to generate, based on the video template, a video that is the same with or is similar to the first video. For example, another user may not be able to generate, based on a video template, video content with an effect similar to a first video because quality of the video template is not detected.

In the process of solving the above technical problem, it is found in research that, in order to accurately identify template quality of a video template, after a first video generated based on a preset template and a first material is obtained, a second video can be generated based on the preset template and a preset second material with simple content.

Highlight segments in the first video and the second video are respectively identified. Overlapping time ranges of the identified highlight segments in the first video and the second video are determined. For the overlapping time ranges, video processing elements corresponding to the overlapping time ranges are determined from a template generation protocol associated with the preset template. Whether highlight effects of the highlight segments are obtained by processing the video processing elements is determined. Thus, the template quality of the preset template can be determined based on a processing result.

Further, after the template quality of each preset template is determined, the preset template can be also pushed to a user based on the template quality.

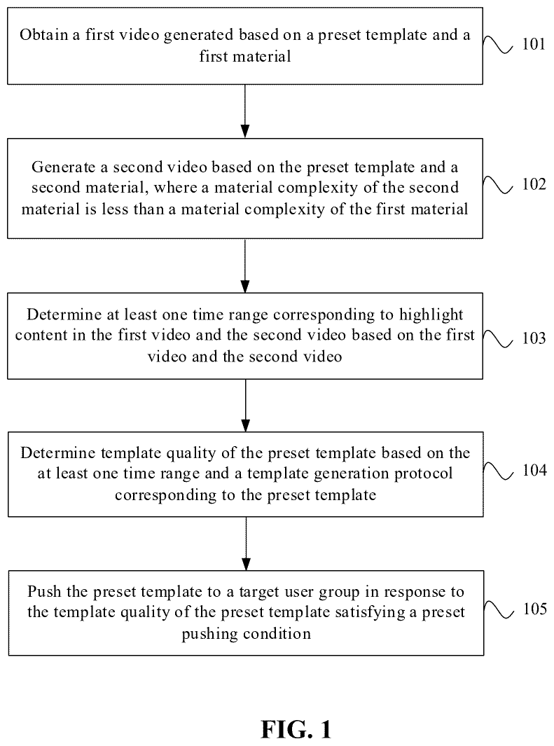

FIG. 1 is a schematic flowchart of a template processing method according to an embodiment of the present disclosure. As shown in FIG. 1, the method includes the following steps.

At step 101, a first video generated based on a preset template and a first material is obtained.

An executive body of this embodiment is a template processing apparatus. The template processing apparatus may be coupled to a server. Thus, the first video can be obtained, and the second video can be generated based on the preset template associated with the first video. A verification operation is performed with respect to the template quality of the preset template based on the first video, second video, and a template generation protocol corresponding to the preset template.

In this implementation, a user can generate the preset template in a preset application according to an actual need. The preset template may include a video processing element such as an effect, a filter, and a transition. After the video template is generated, the user can post the first video generated based on the preset template and the preset first material. The first material may be original material content selected by the user according to an actual need. The template processing apparatus may obtain the first video.

Since a visual effect presented by the first video is comprehensively determined by the preset template and the first material, whether a video effect of the first video is a video processing effect of the preset template or an effect generated by the first material cannot be determined. Therefore, the template quality of the preset template needs to be detected.

At step 102, a second video is generated based on the preset template and a second material. A material complexity of the second material is less than a material complexity of the first material.

Optionally, in order to accurately determine the template quality of the preset template, the second material may be set in advance. The material complexity of the second material is often less than the material complexity of the first material. For example, the second material may be a pure color material, a portrait material with a single background, or the like. Since the second material itself does not have a dynamic and fantastic display effect, the video processing effect of the preset template can be presented more accurately. Therefore, after the first video is compared with the second video, it is possible to accurately determine whether the video effect of the first video is the video processing effect of the preset template or the effect generated by the first material.

Further, after the first video is obtained, the second video is generated based on the preset template associated with the first video and the preset second material.

For example, the second material may be added to a corresponding position in the preset template, and the second material may be processed based on a video processing element at a corresponding position, to obtain the second video.

At step 103, at least one time range corresponding to highlight content in the first video and the second video is determined based on the first video and the second video.

In this implementation, after the first video and the second video are obtained respectively, the highlight content in the first video and the second video is determined, and the at least one time range is determined based on the highlight content.

The highlight content in the first video and the second video can be identified. The at least one time range may be an overlapping time range corresponding to the highlight content in the first video and the second video.

By identifying the highlight content, it can be further determined whether the highlight content is generated based on the preset template or based on content of the materials. Thus, the template quality of the preset template can be identified based on a determining result.

At step 104, template quality of the preset template is determined based on the at least one time range and a template generation protocol corresponding to the preset template. The template generation protocol includes at least one video processing element associated with the preset template and a time range associated with the at least one video processing element.

In this implementation, the preset template may be generated by a user based on the template generation protocol. The template generation protocol may include at least one video processing element associated with the preset template and a time range associated with the video processing element. For example, the template generation protocol may include a timeline. Different video processing elements may be distributed on the timeline and respectively cover corresponding time ranges. The video processing elements include but are not limited to an effect element, a filter element, a transition element, a sticker element, a graffiti element, and the like. The present disclosure does not limit this.

Further, after the at least one time range is determined, for each time range, a video processing element matching with the time range may be determined based on the template generation protocol. Thus, the template quality corresponding to the preset template can be accurately identified based on the video processing elements and video effects associated with the time ranges.

At step 105, the preset template is pushed to a target user group in response to the template quality of the preset template satisfying a preset pushing condition.

In this implementation, the preset pushing condition may be set in advance. The preset pushing condition may be for pushing a preset template with high template quality. For example, a pushing operation may be performed on a preset template by which all highlight effects of highlight content are generated.

When it is determined that the template quality of the preset template meets the preset push conditions, the preset template may be pushed to the target user group.

In a possible implementation, preset templates with different template qualities may be respectively pushed to different user groups.

Alternatively, a template category of the preset template may be determined and pushed to a user group that is matched with the template category.

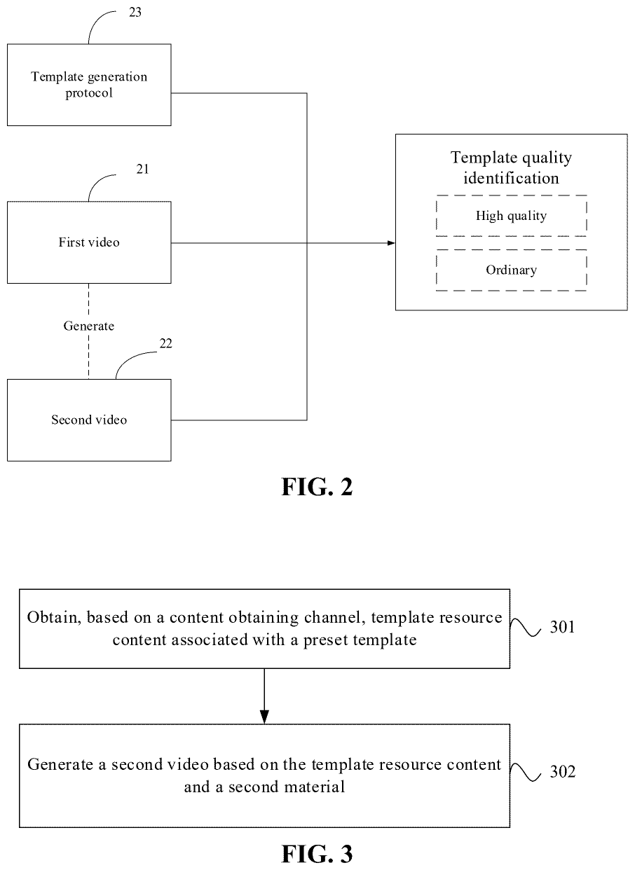

FIG. 2 is a schematic diagram of an application scene according to this embodiment of the present disclosure. After a first video 21 is obtained, a second video 22 may be generated, based on a preset template resource which is obtained based on a content obtaining channel associated with a preset template carried in the first video 21. Template quality of a second video template is identified based on the first video 21, the second video 22, and a template generation protocol 23 associated with the preset template. When the template quality satisfies a preset pushing conditions, the preset template is pushed to a target user group.

According to the template processing method provided in this embodiment, after a first video is obtained, a second video is generated based on a preset template associated with the first video and a preset second material. At least one time range is determined based on at least one first video frame in the first video that satisfies a preset filtering condition and at least one second video frame in the second video that satisfies the preset filtering condition, and template quality corresponding to the preset template is determined based on the time range and a template generation protocol associated with the preset template. Thus, the template quality of the preset template can be accurately identified. When the preset template satisfies the preset pushing condition, the preset template is pushed to a user, so that the user can generate, based on the preset template, video content that is similar to the first video.

FIG. 3 is a schematic flowchart of a template processing method according to another embodiment of the present disclosure. Based on any one of the above embodiments, as shown in FIG. 3, the first video includes a content obtaining channel associated with the preset template. Step 101 includes:
at step 301, obtaining, based on the content obtaining channel, template resource content associated with the preset template.
at step 302, generating the second video based on the template resource content and the second material.

In this embodiment, the first video includes the content obtaining channel associated with the preset template. The content obtaining channel may be displayed in the form of an anchor point.

Thus, after the first video is obtained, the template resource content associated with the preset template may be obtained based on the content obtaining channel.

Further, after the template resource content is obtained, the second video may be generated based on the template resource content and the pre-stored second material. The second material may be added to a corresponding position in the preset template, and the second material may be processed based on a video processing element at a corresponding position, to obtain the second video.

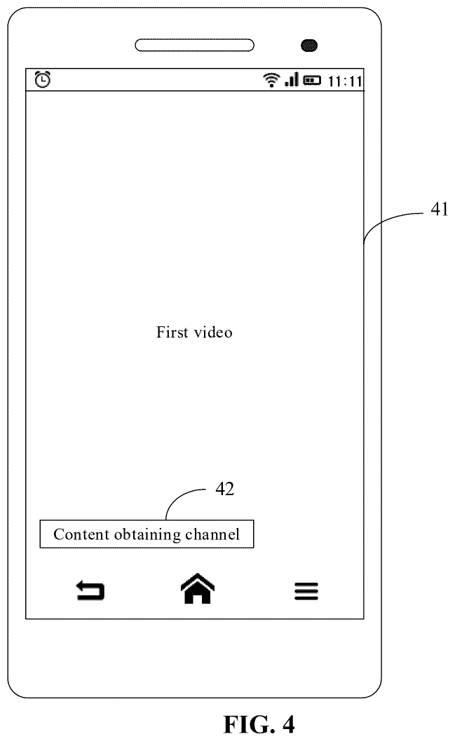

FIG. 4 is a schematic diagram of a first video according to an embodiment of the present disclosure. As shown in FIG. 4, a first video 41 includes a content obtaining channel 42 associated with a preset template. The content obtaining channel 42 may be displayed in the form of an anchor point.

According to the template processing method provided in this embodiment, by the content obtaining channel associated with the preset template carried in the first video, after the first video is obtained, the template resource content can be quickly obtained through the content obtaining channel, so that the second video can be generated based on the template resource content and the pre-stored second material.

Further, based on any one of the above embodiments, step 302 includes:
determining usage states of a plurality of preset video generation devices, where an usage state of the usage states includes an idle state and an occupied state;
sending the template resource content to any video generation device with the usage state being the idle state, to cause the video generation device to generate the second video based on the template resource content and the preset second material; and obtaining the second video sent by the video generation device.

In this embodiment, due to a large number of preset templates, in order to satisfy a verification operation on a plurality of preset templates, a plurality of video generation devices may be configured in advance, to generate the second video through the plurality of video generation devices.

In a possible implementation, when a plurality of preset templates exist simultaneously, the plurality of preset templates may be added into a message queue based on verification time. Thus, a verification operation is performed on the preset templates in sequence in the message queue.

Further, during the verification on the preset template, the usage states of the plurality of preset video generation devices may be determined. An usage state of the usage states includes the idle state and the occupied state. The video generation devices that are currently in the idle state are determined based on the usage states. The template resource content is sent to any video generation device with the usage state being the idle state, to cause the video generation device to generate the second video based on the template resource content and the preset second material. The second video sent by the video generation device is obtained.

According to the template processing method provided in this embodiment, by configuring the plurality of video generation devices in advance, after the template resource content is obtained, the video generation device in the idle state can be selected from the plurality of video generation devices to generate the second video, so that template verification efficiency is improved. In addition, by the arrangement of the plurality of video devices, it can be supported that a quality verification operation is simultaneously performed on the plurality of preset templates.

Further, based on any one of the above embodiments, step 102 includes:
determining at least one first video frame in the first video that satisfies a preset filtering condition and at least one second video frame in the second video that satisfies the preset filtering condition; and
determining the at least one time range based on the at least one first video frame and the at least one second video frame.

In this embodiment, in order to accurately determine the template quality of the preset template, the at least one first video frame in the first video that satisfies the preset filtering condition and the at least one second video frame in the second video that satisfies the preset filtering condition can be respectively determined. The preset filtering condition may be for filtering a highlight frame with a good display effect.

Optionally, when a highlight frame in the first video and a highlight frame in the second video overlap, it can represent that a video processing element for video processing may exist in the preset template within the time range. Therefore, during the respectively determining the at least one first video frame and the at least one second video frame, the at least one time range can be determined based on the at least one first video frame and the at least one second video frame.

According to the template processing method provided in this embodiment, by setting a filtering condition in advance, an extraction operation can be performed on a highlight video frame based on the filtering condition, so that a time range can be accurately identified based on the highlight video frame.

Optionally, based on any one of the above embodiments, determining the at least one first video frame in the first video that satisfies the preset filtering condition and the at least one second video frame in the second video that satisfies the preset filtering condition includes:
performing a frame extraction operation on the first video based on a preset frame extraction parameter, to obtain a plurality of first video frames to be filtered, where the frame extraction parameter includes a frame extraction frequency and a frame extraction number;
for each first video frame to be filtered, identifying a plurality of dimensions of image parameters associated with the first video frames to be filtered through a preset image identification algorithm;
performing, based on a weight parameter corresponding to each dimension of image with the first video frames to be filtered, to obtain a first weighting result;
determining a first video frame to be filtered with a first weighting result greater than a preset threshold as the first video frame;
and
performing a frame extraction operation on the second video based on a preset frame extraction parameter, to obtain a plurality of second video frames to be filtered, where the frame extraction parameter includes a frame extraction frequency and a frame extraction number;
for each second video frame to be filtered, identifying a plurality of dimensions of image parameters associated with the second video frames to be filtered through a preset image identification algorithm;
performing, based on a weight parameter corresponding to each dimension of image parameter, a weighting operation on the plurality of dimensions of image parameters associated with the second video frames to be filtered, to obtain a second weighting result; and
determining a second video frame to be filtered with a second weighting result being greater than the preset threshold as the second video frame.

In this embodiment, for the first video, the frame extraction operation is performed on the first video based on the preset frame extraction parameter, to obtain the plurality of first video frames to be filtered, where the frame extraction parameter includes the frame extraction frequency and the frame extraction number. For example, the frame extraction operation can be performed on the first video based on a frame extraction parameter, i.e., 10 frames per second.

Further, for each first video frame to be filtered, the plurality of dimensions of image parameters associated with the first video frames to be filtered are identified through the preset image identification algorithm. For example, color brightness, clarity, face quality, aesthetic quality, and a meaningless image (such as an image with unclear content, an out-of-focus image, and a low-clarity image) that are associated with the first video frames to be filtered may be identified and scored, and the scores of the above plurality of dimension indicators may be used as the plurality of dimensions of image parameters.

Further, a weighting operation may be performed, based on a weight parameter corresponding to each dimension of image parameter, on the plurality of dimensions of image parameters associated with the first video frame to be filtered, to obtain a first weighting result. The first video frame to be filtered with the first weighting result greater than the preset threshold may be determined as the first video frame. For example, a score range of the weighting results may be (0-1), and a first video frame to be filtered with a score greater than 0.9 may be determined as the first video frame.

Optionally, for the second video, the frame extraction operation is performed on the second video based on the preset frame extraction parameter, to obtain the plurality of second video frames to be filtered, where the frame extraction parameter includes the frame extraction frequency and the frame extraction number. For example, the frame extraction operation can be performed on the second video based on a frame extraction parameter, i.e., 10 frames per second.

Further, for each second video frame to be filtered, the plurality of dimensions of image parameters associated with the second video frames to be filtered are identified through the preset image identification algorithm. For example, color brightness, clarity, face quality, aesthetic quality, and a meaningless image (such as an image with unclear content, an out-of-focus image, and a low-clarity image) that are associated with the second video frames to be filtered may be identified and scored, and the scores of the above plurality of dimension indicators may be used as the plurality of dimensions of image parameters. A weighting operation may be performed, based on a weight parameter corresponding to each dimension of image parameter, on the plurality of dimensions of image parameters associated with the second video frames to be filtered, to obtain a second weighting result. The second video frame to be filtered with the second weighting result being greater than the preset threshold may be determined as the second video frame. For example, a score range of the weighting results may be (0-1), and a second video frame to be filtered with a score greater than 0.9 may be determined as the second video frame.

Further, based on any one of the above embodiments, determining the at least one time range based on the at least one first video frame and the at least one second video frame includes:
determining at least one first time range corresponding to the at least one first video frame, and determining at least one second time range corresponding to the at least one second video frame;
determining at least one overlapping time range overlapped among the at least one first time range and at least one second time range; and
determining the at least one overlapping time range as the at least one time range.

In this embodiment, the at least one first video frame may be at least one highlight frame in the first video. The a least one second video frame may be at least one highlight frame in the second video. When a highlight frame in the first video and a highlight frame in the second video overlap, it can represent that a video processing element for video processing may exist in the preset template within the time range.

Optionally, the at least one first video frame in the first video may correspond to at least one first time range, and the at least one second video frame in the second video may correspond to at least one second time range. After the at least one first time range and the at least one second time range are respectively determined, the at least one overlapping time range may be determined as the at least one time range.

According to the template processing method provided in this embodiment, the highlight frames in the first video and the second video are respectively identified, and a time range overlapped among the highlight frames is determined as the at least one time range, so that a video processing element in the template generation protocol can be determined based on the time range. Further, whether the highlight effects of the highlight frames are generated by the preset template or by content of the materials can be determined; and the template quality of the preset template can be determined accurately based on a processing result.

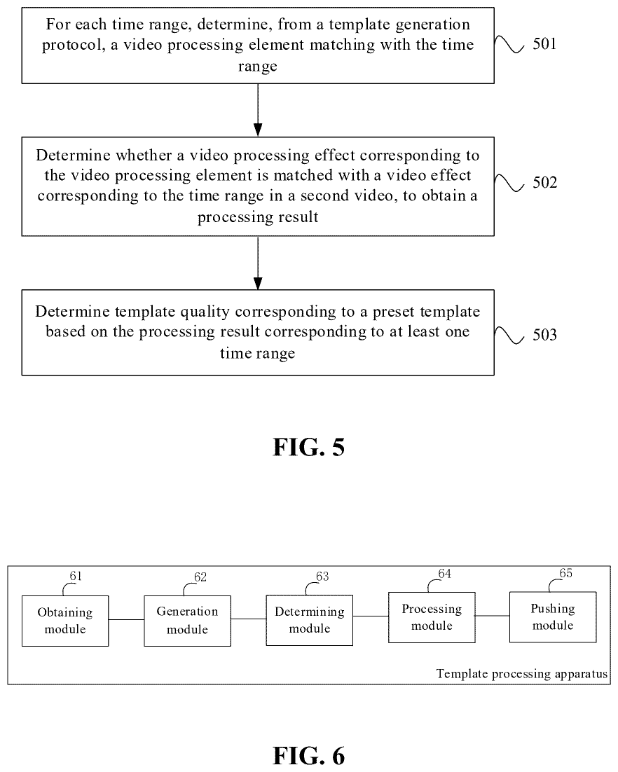

FIG. 5 is a schematic flowchart of a template processing method according to still another embodiment of the present disclosure. Based on any one of the above embodiments, as shown in FIG. 5, step 103 includes:
at step 501, for each time range, determining, from the template generation protocol, a video processing element matching with the time range;
at step 502, determining whether a video processing effect corresponding to the video processing element is matched with a video effect corresponding to the time range in the second video, to obtain a processing result; and
at step 503, determining the template quality corresponding to the preset template based on the processing result corresponding to the at least one time range.

In this embodiment, the template generation protocol includes a plurality of video processing elements and time ranges corresponding to the video processing elements. Therefore, after the at least one time range is determined, the video processing element matching with the time range can be determined in a template to be verified.

Further, the video processing effect corresponding to the video processing element can be determined. Whether the video processing effect corresponding to the video processing element is matched with the video effect corresponding to the time range in the second video is determined, to obtain the processing result.

It can be understood that when the video processing effect corresponding to the video processing element is matched with the video effect associated with the second video, it indicates that the video effect is generated by the video processing result of the preset template. On the contrary, it indicates that the video processing effect is generated by the content of the material itself.

By determining whether the video processing effect corresponding to the video processing element is matched with the video effect corresponding to the time range in the second video, the template quality corresponding to the preset template can be accurately determined based on the processing result.

According to the template processing method provided in this embodiment, by determining the video processing element in the template generation protocol based on the time range and determining whether the video processing effect corresponding to the video processing element is matched with the video effect corresponding to the time range in the second video, whether the highlight effects of the highlight frames are generated by the preset template or the content of the materials can be determined, and the template quality of the preset template can be accurately determined based on the processing result.

Further, based on any one of the above embodiments, step 503 includes:
determining a target number of the time ranges within which the video processing effect corresponding to the video processing element is matched with the video effect associated with the second video;
determining a target proportion of the target number over the at least one time range; and
determining the template quality corresponding to the preset template based on the target proportion and a preset proportion threshold.

In this embodiment, when the video processing effect corresponding to the video processing element is matched with the video effect associated with the second video, it indicates that the video effect is generated by the video processing result of the preset template. Therefore, if the video processing effects corresponding to most video processing elements are matched with the video effect associated with the second video, it indicates that most highlight effects in both the first video and the second video are all generated by the preset template, which means that the template quality of the preset template is high.

Therefore, the target number of the time ranges within which the video processing effect corresponding to the video processing element is matched with the video effect associated with the second video can be determined. The target proportion of the target number over the at least one time range can be determined. The template quality corresponding to the preset template can be determined based on the target proportion and a preset proportion threshold. For example, the proportion threshold may be 80%. Alternatively, a user can also adjust the proportion threshold according to an actual need. The present disclosure does not impose a limitation on this.

For example, there may be 10 time ranges. If the target number of the time ranges within which the video processing effect corresponding to the video processing element is matched with the video effect associated with the second video is equal to nine, 90% of the highlight effects are generated by the preset template. The target proportion is greater than the preset proportion threshold, which means that the template quality of the preset template is high.

According to the template processing method provided in this embodiment, by determining the target number of the time ranges within which the video processing effect corresponding to the video processing element is matched with the video effect associated with the second video, determining the target proportion of the target number over the at least one time range, and determining the template quality corresponding to the preset template based on the target proportion and a preset proportion threshold, template quality of a template to be verified can be accurately identified.

FIG. 6 is a schematic structural diagram of a template processing apparatus according to an embodiment of the present disclosure. As shown in FIG. 6, the apparatus includes: an obtaining module 61, a generation module 62, a determining module 63, a processing module 64, and a pushing module 65. The obtaining module 61 is configured to obtain a first video generated based on a preset template and a first material. The generation module 62 is configured to generate a second video based on the preset template and a second material. A material complexity of the second material is less than a material complexity of the first material. The determining module 63 is configured to determine at least one time range corresponding to highlight content in the first video and the second video based on the first video and the second video. The processing module 64 is configured to determine template quality of the preset template based on the at least one time range and a template generation protocol corresponding to the preset template. The template generation protocol includes at least one video processing element associated with the preset template and a time range associated with the at least one video processing element. The pushing module 65 is configured to push the preset template to a target user group in response to the template quality of the preset template satisfying a preset pushing condition.

Further, based on any one of the above embodiments, the first video includes a content obtaining channel associated with the preset template. The obtaining module is configured to obtain, based on the content obtaining channel, template resource content associated with the preset template; and generate the second video based on the template resource content and the second material.

Further, based on any one of the above embodiments, the obtaining module is configured to determine usage states of a plurality of preset video generation devices, where an usage state of the usage states includes an idle state and an occupied state; send the template resource content to any video generation device with the usage state being the idle state, to cause the video generation device to generate the second video based on the template resource content and the second material; and obtain the second video sent by the video generation device.

Further, based on any one of the above embodiments, the determining module is configured to determine at least one first video frame in the first video that satisfies a preset filtering condition and at least one second video frame in the second video that satisfies the preset filtering condition; and

determine the at least one time range based on the at least one first video frame and the at least one second video frame.

Further, based on any one of the above embodiments, the determining module is configured to: perform a frame extraction operation on the first video based on a preset frame extraction parameter, to obtain a plurality of first video frames to be filtered, where the frame extraction parameter includes a frame extraction frequency and a frame extraction number; for each first video frame to be filtered, identify a plurality of dimensions of image parameters associated with the first video frames to be filtered through a preset image identification algorithm; perform, based on a weight parameter corresponding to each dimension of image parameter, a weighting operation on the plurality of dimensions of image parameters associated with the first video frames to be filtered, to obtain a first weighting result; determine a first video frame to be filtered with a first weighting result greater than a preset threshold as the first video frame; and perform a frame extraction operation on the second video based on a preset frame extraction parameter, to obtain a plurality of second video frames to be filtered, where the frame extraction parameter includes a frame extraction frequency and a frame extraction number; for each second video frame to be filtered, identify a plurality of dimensions of image parameters associated with the second video frames to be filtered through a preset image identification algorithm; perform, based on a weight parameter corresponding to each dimension of image parameter, a weighting operation on the plurality of dimensions of image parameters associated with the second video frames to be filtered, to obtain a second weighting result; and determine a second video frame to be filtered with a second weighting result being greater than the preset threshold as the second video frame.

Further, based on any one of the above embodiments, the determining module is configured to determine at least one first time range corresponding to the at least one first video frame, and determine at least one second time range corresponding to the at least one second video frame; determine at least one overlapping time range overlapped among the at least one first time range and at least one second time range; and determine the at least one overlapping time range as the at least one time range.

Further, based on any one of the above embodiments, the processing module is configured to, for each time range, determine, from the template to be verified, a video processing element matching with the time range; determine whether a video processing effect corresponding to the video processing element is matched with a video effect corresponding to the time range in the second video, to obtain a processing result; and determine the template quality corresponding to the preset template based on the processing result corresponding to the at least one time range.

Further, based on any one of the above embodiments, the processing module is configured to: determine a target number of the time ranges within which the video processing effect corresponding to the video processing element is matched with the video effect associated with the second video; determine a target proportion of the target number over the at least one time range; and determine the template quality corresponding to the preset template based on the target proportion and a preset proportion threshold.

The device provided in this embodiment can be configured to implement the technical solutions of the method embodiments described above, and an implementation principle and technical effects thereof are similar to those of the method embodiments, so that the device will not be described in detail in this embodiment.

In order to achieve the above embodiments, an embodiment of the present disclosure further provides a computer-readable storage medium storing computer-executable instructions. The computer-executable instructions, when executed by a processor, implement the template processing method as described in any one of the above embodiments.

In order to achieve the above embodiments, an embodiment of the present disclosure further provides a computer program product including computer programs. The computer programs, when executed by a processor, implement the template processing method as described in any one of the above embodiments.

In order to achieve the above embodiments, an embodiment of the present disclosure further provides an electronic device, including: a processor and a memory.

The memory stores computer-executable instructions.

The processor executes the computer-executable instructions stored in the memory, to cause the processor to perform the template processing method as described in any one of the above embodiments.

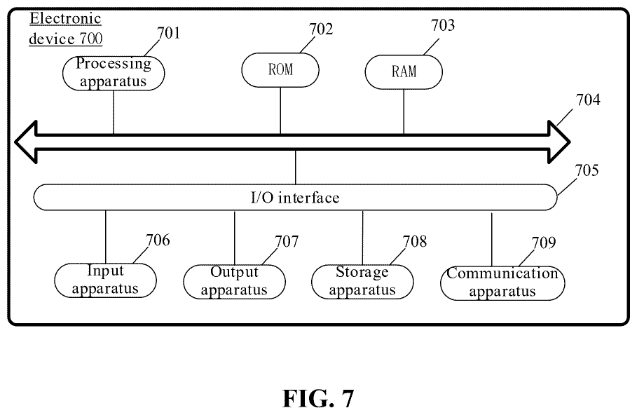

FIG. 7 is a schematic structural diagram of an electronic device according to an embodiment of the present disclosure. The electronic device 700 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to a bus 704.

Usually, following apparatuses can be connected to the I/O interface 705: an input apparatus 706 including a touch screen, a touchpad, a keyboard, a mouse, a camera, a microphone, an accelerometer, a gyroscope, and the like; an output apparatus 707 including a Liquid Crystal Display (LCD), a speaker, a vibrator, and the like; a storage apparatus 708 including a magnetic tape, a hard disk drive, and the like; and a communication apparatus 709. The communication apparatus 709 can allow the electronic device 700 to wirelessly or wiredly communicate with other devices to exchange data. Although FIG. 7 shows the electronic device 700 with multiple apparatuses, it should be understood that the electronic device 700 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including computer programs carried on a computer-readable medium, and the computer programs include program codes used for performing the methods shown in the flowcharts. In such an embodiment, the computer program may be downloaded and installed from a network through the communication apparatus 709, or installed from the memory 708, or installed from the ROM 702. When the computer program is executed by the processing apparatus 701, the above-mentioned functions defined in the methods of the embodiments of the present application are executed.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an erasable programmable read-only memory (EPROM) or flash memory, an optical fiber, a compact disc read-only memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signal may be in various forms, including but not limited to an electromagnetic signal, an optical signal, or any suitable combination thereof. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), and the like, or any suitable combination of the above.

The computer-readable medium may be included in the electronic device or exist alone and is not assembled into the electronic device.

The above computer-readable medium carries one or more programs. When executed by the electronic device, the one or more programs cause the electronic device to implement the methods shown in the above embodiments.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case that a remote computer is involved, the remote computer can be connected to a user computer through any kind of networks, including a LAN or a WAN, or can be connected to an external computer (e.g., through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, non-restrictively, example hardware logic components that can be used include: a field programmable gate array (FPGA), an application specific integrated circuit (ASIC), application specific standard parts (ASSP), a system on chip (SOC), a complex programmable logic device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

In a first aspect, according to one or more embodiments of the present disclosure, a template processing method is provided. The method includes:
obtaining a first video generated based on a preset template and a first material;
generating a second video based on the preset template and a second material, where a material complexity of the second material is less than a material complexity of the first material;
determining at least one time range corresponding to highlight content in the first video and the second video based on the first video and the second video;
determining template quality of the preset template based on the at least one time range and a template generation protocol corresponding to the preset template, where the template generation protocol includes at least one video processing element associated with the preset template and a time range associated with the at least one video processing element; and
pushing the preset template to a target user group in response to the template quality of the preset template satisfying a preset pushing condition.

According to one or more embodiments of the present disclosure, the first video includes a content obtaining channel associated with the preset template; and
generating the second video based on the preset template and a preset second material includes:
obtaining, based on the content obtaining channel, template resource content associated with the preset template; and
generating the second video based on the template resource content and the second material.

According to one or more embodiments of the present disclosure, generating the second video based on the template resource content and the preset second material includes:
determining usage states of a plurality of preset video generation devices, where an usage state of the usage states includes an idle state and an occupied state;
sending the template resource content to any video generation device with the usage state being the idle state, to cause the video generation device to generate the second video based on the template resource content and the second material; and
obtaining the second video sent by the video generation device.

According to one or more embodiments of the present disclosure, determining at least one time range corresponding to highlight content in the first video and the second video based on the first video and the second video includes:
determining at least one first video frame in the first video that satisfies a preset filtering condition and at least one second video frame in the second video that satisfies the preset filtering condition; and
determining the at least one time range based on the at least one first video frame and the at least one second video frame.

According to one or more embodiments of the present disclosure, determining at least one first video frame in the first video that satisfies a preset filtering condition and at least one second video frame in the second video that satisfies the preset filtering condition includes:
performing a frame extraction operation on the first video based on a preset frame extraction parameter, to obtain a plurality of first video frames to be filtered, where the frame extraction parameter includes a frame extraction frequency and a frame extraction number;
for each first video frame to be filtered, identifying a plurality of dimensions of image parameters associated with the first video frames to be filtered through a preset image identification algorithm;
performing, based on a weight parameter corresponding to each dimension of image parameter, a weighting operation on the plurality of dimensions of image parameters associated with the first video frames to be filtered, to obtain a first weighting result;
determining a first video frame to be filtered with a first weighting result greater than a preset threshold as the first video frame;
and
performing a frame extraction operation on the second video based on a preset frame extraction parameter, to obtain a plurality of second video frames to be filtered, where the frame extraction parameter includes a frame extraction frequency and a frame extraction number;
for each second video frame to be filtered, identifying a plurality of dimensions of image parameters associated with the second video frames to be filtered through a preset image identification algorithm;
performing, based on a weight parameter corresponding to each dimension of image with the second video frames to be filtered, to obtain a second weighting result; and
determining a second video frame to be filtered with a second weighting result being greater than the preset threshold as the second video frame.

According to one or more embodiments of the present disclosure, determining the at least one time range based on the at least one first video frame and the at least one second video frame includes:
determining at least one first time range corresponding to the at least one first video frame, and determining at least one second time range corresponding to the at least one second video frame;
determining at least one overlapping time range overlapped among the at least one first time range and at least one second time range; and
determining the at least one overlapping time range as the at least one time range.

According to one or more embodiments of the present disclosure, determining the template quality of the preset template based on the at least one time range and the template generation protocol corresponding to the preset template includes:
for each time range, determining, from the template to be verified, a video processing element matching with the time range;
determining whether a video processing effect corresponding to the video processing element is matched with a video effect corresponding to the time range in the second video, to obtain a processing result; and
determining the template quality corresponding to the preset template based on the processing result corresponding to the at least one time range.

According to one or more embodiments of the present disclosure, determining the template quality corresponding to the preset template based on the processing result corresponding to the at least one time range includes:
determining a target number of the time ranges within which the video processing effect corresponding to the video processing element is matched with the video effect associated with the second video;
determining a target proportion of the target number over the at least one time range; and
determining the template quality corresponding to the preset template based on the target proportion and a preset proportion threshold.

In a second aspect, according to one or more embodiments of the present disclosure, a template processing apparatus is provided. The apparatus includes:
an obtaining module configured to obtain a first video generated based on a preset template and a first material;
a generation module configured to generate a second video based on the preset template and a second material, where a material complexity of the second material is less than a material complexity of the first material;
a determining module configured to determine at least one time range corresponding to highlight content in the first video and the second video based on the first video and the second video;
a processing module configured to determine template quality of the preset template based on the at least one time range and a template generation protocol corresponding to the preset template, where the template generation protocol includes at least one video processing element associated with the preset template and a time range associated with the at least one video processing element; and
a pushing module configured to push the preset template to a target user group in response to the template quality of the preset template satisfying a preset pushing condition.

According to one or more embodiments of the present disclosure, the first video includes a content obtaining channel associated with the preset template; and
the obtaining module is configured to:
obtain, based on the content obtaining channel, template resource content associated with the preset template; and
generate the second video based on the template resource content and the second material.

According to one or more embodiments of the present disclosure, the obtaining module is configured to:
determine usage states of a plurality of preset video generation devices, where an usage state of the usage states includes an idle state and an occupied state;
send the template resource content to any video generation device with the usage state being the idle state, to cause the video generation device to generate the second video based on the template resource content and the second material; and
obtain the second video sent by the video generation device.

According to one or more embodiments of the present disclosure, the determining module is configured to: determine at least one first video frame in the first video that satisfies a preset filtering condition and at least one second video frame in the second video that satisfies the preset filtering condition; and
determine the at least one time range based on the at least one first video frame and the at least one second video frame.

According to one or more embodiments of the present disclosure, the determining module is configured to:
perform a frame extraction operation on the first video based on a preset frame extraction parameter, to obtain a plurality of first video frames to be filtered, where the frame extraction parameter includes a frame extraction frequency and a frame extraction number;
for each first video frame to be filtered, identify a plurality of dimensions of image parameters associated with the first video frames to be filtered through a preset image identification algorithm;
perform, based on a weight parameter corresponding to each dimension of image parameter, a weighting operation on the plurality of dimensions of image parameters associated with the first video frames to be filtered, to obtain a first weighting result;
determine a first video frame to be filtered with a first weighting result greater than a preset threshold as the first video frame;
and
perform a frame extraction operation on the second video based on a preset frame extraction parameter, to obtain a plurality of second video frames to be filtered, where the frame extraction parameter includes a frame extraction frequency and a frame extraction number;
for each second video frame to be filtered, identify a plurality of dimensions of image parameters associated with the second video frames to be filtered through a preset image identification algorithm;
perform, based on a weight parameter corresponding to each dimension of image parameter, a weighting operation on the plurality of dimensions of image parameters associated with the second video frames to be filtered, to obtain a second weighting result; and
determine a second video frame to be filtered with a second weighting result being greater than the preset threshold as the second video frame.

According to one or more embodiments of the present disclosure, the determining module is configured to:
determine at least one first time range corresponding to the at least one first video frame, and determine at least one second time range corresponding to the at least one second video frame;
determine at least one overlapping time range overlapped among the at least one first time range and at least one second time range; and
determine the at least one overlapping time range as the at least one time range.

According to one or more embodiments of the present disclosure, the processing module is configured to:
for each time range, determine, from the template to be verified, a video processing element matching with the time range;
determine whether a video processing effect corresponding to the video processing element is matched with a video effect corresponding to the time range in the second video, to obtain a processing result; and
determine the template quality corresponding to the preset template based on the processing result corresponding to the at least one time range.

According to one or more embodiments of the present disclosure, the processing module is configured to:
determine a target number of the time ranges within which the video processing effect corresponding to the video processing element is matched with the video effect associated with the second video;
determine a target proportion of the target number over the at least one time range; and
determine the template quality corresponding to the preset template based on the target proportion and a preset proportion threshold.

In a third aspect, according to one or more embodiments of the present disclosure, an electronic device is provided, including: at least one processor and a memory.

The memory stores computer-executable instructions.

The at least one processor executes the computer-executable instructions stored in the memory, to cause the at least one processor to perform the template processing method in the first aspect and in various possible designs of the first aspect.

In a fourth aspect, according to one or more embodiments of the present disclosure, a computer-readable storage medium is provided, and the computer-readable storage medium stores computer-executable instructions. The computer-executable instructions, when executed by a processor, implement the template processing method in the first aspect and in various possible designs of the first aspect.

In a fifth aspect, according to one or more embodiments of the present disclosure, a computer program product is provided. The computer program product includes computer programs. The computer programs, when executed by a processor, implement the template processing method in the first aspect and in various possible designs of the first aspect.

The foregoing descriptions are merely preferred embodiments of the present disclosure and explanations of the applied technical principles. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, For example, a technical solution formed by a replacement of the foregoing features with technical features with similar functions disclosed in the present disclosure (but not limited thereto) also falls within the scope of the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

I/We claim:

1. A template processing method, comprising:
obtaining a first video generated based on a preset template and a first material;
generating a second video based on the preset template and a second material, wherein a material complexity of the second material is less than a material complexity of the first material;
determining at least one time range corresponding to highlight content in the first video and the second video based on the first video and the second video;
determining template quality of the preset template based on the at least one time range and a template generation protocol corresponding to the preset template, the template generation protocol comprising at least one video processing element associated with the preset template and a time range associated with the at least one video processing element; and
pushing the preset template to a target user group in response to the template quality of the preset template satisfying a preset pushing condition.

2. The method according to claim 1, wherein the first video comprises a content obtaining channel associated with the preset template; and
wherein generating the second video based on the preset template and the second material comprises:
obtaining, based on the content obtaining channel, template resource content associated with the preset template; and
generating the second video based on the template resource content and the second material.

3. The method according to claim 2, wherein generating the second video based on the template resource content and the second material comprises:
determining usage states of a plurality of preset video generation devices, wherein an usage state of the usage states comprises an idle state and an occupied state;
sending the template resource content to any video generation device with the usage state being the idle state, to cause the video generation device to generate the second video based on the template resource content and the second material; and
obtaining the second video sent by the video generation device.

4. The method according to claim 1, wherein determining the at least one time range corresponding to the highlight content in the first video and the second video based on the first video and the second video comprises:
determining at least one first video frame in the first video that satisfies a preset filtering condition and at least one second video frame in the second video that satisfies the preset filtering condition; and
determining the at least one time range based on the at least one first video frame and the at least one second video frame.

5. The method according to claim 4, wherein determining the at least one first video frame in the first video that satisfies the preset filtering condition and the at least one second video frame in the second video that satisfies the preset filtering condition comprises:
performing a frame extraction operation on the first video based on a preset frame extraction parameter, to obtain a plurality of first video frames to be filtered, wherein the frame extraction parameter comprises a frame extraction frequency and a frame extraction number;
for each first video frame to be filtered, identifying a plurality of dimensions of image parameters associated with the first video frames to be filtered through a preset image identification algorithm;
performing, based on a weight parameter corresponding to each dimension of image parameter, a weighting operation on the plurality of dimensions of image parameters associated with the first video frames to be filtered, to obtain a first weighting result;
determining a first video frame to be filtered with a first weighting result greater than a preset threshold as the first video frame;
and
performing a frame extraction operation on the second video based on a preset frame extraction parameter, to obtain a plurality of second video frames to be filtered, wherein the frame extraction parameter comprises a frame extraction frequency and a frame extraction number;
for each second video frame to be filtered, identifying a plurality of dimensions of image parameters associated with the second video frames to be filtered through a preset image identification algorithm;
performing, based on a weight parameter corresponding to each dimension of image with the second video frames to be filtered, to obtain a second weighting result; and
determining a second video frame to be filtered with a second weighting result greater than the preset threshold as the second video frame.

6. The method according to claim 4, wherein determining the at least one time range based on the at least one first video frame and the at least one second video frame comprises:
determining at least one first time range corresponding to the at least one first video frame, and determining at least one second time range corresponding to the at least one second video frame;
determining at least one overlapping time range overlapped among the at least one first time range and at least one second time range; and
determining the at least one overlapping time range as the at least one time range.

7. The method according to claim 1, wherein determining the template quality of the preset template based on the at least one time range and the template generation protocol corresponding to the preset template comprises:
for each time range, determining, from the template generation protocol, a video processing element matching with the time range;
determining whether a video processing effect corresponding to the video processing element is matched with a video effect corresponding to the time range in the second video, to obtain a processing result; and
determining the template quality corresponding to the preset template based on the processing result corresponding to the at least one time range.

8. The method according to claim 7, wherein determining the template quality corresponding to the preset template based on the processing result corresponding to the at least one time range comprises:
determining a target number of time ranges within which the video processing effect corresponding to the video processing element is matched with the video effect associated with the second video;
determining a target proportion of the target number over the at least one time range; and
determining the template quality corresponding to the preset template based on the target proportion and a preset proportion threshold.

9. An electronic device, comprising a processor and a memory;
the memory storing computer-executable instructions; and
the processor executing the computer-executable instructions stored in the memory, to configure the processor to:
obtain a first video generated based on a preset template and a first material;
generate a second video based on the preset template and a second material, wherein a material complexity of the second material is less than a material complexity of the first material;
determine at least one time range corresponding to highlight content in the first video and the second video based on the first video and the second video;
determine template quality of the preset template based on the at least one time range and a template generation protocol corresponding to the preset template, the template generation protocol comprising at least one video processing element associated with the preset template and a time range associated with the at least one video processing element; and
push the preset template to a target user group in response to the template quality of the preset template satisfying a preset pushing condition.

10. The electronic device according to claim 9, wherein the first video comprises a content obtaining channel associated with the preset template; and
wherein the computer-executable instructions to configure the processor to generate the second video based on the preset template and the second material comprise computer-executable instructions to configure the processor to:
obtain, based on the content obtaining channel, template resource content associated with the preset template; and
generate the second video based on the template resource content and the second material.

11. The electronic device according to claim 10, wherein the computer-executable instructions to configure the processor to generate the second video based on the template resource content and the second material comprise computer-executable instructions to configure the processor to:
determine usage states of a plurality of preset video generation devices, wherein an usage state of the usage states comprises an idle state and an occupied state;
send the template resource content to any video generation device with the usage state being the idle state, to cause the video generation device to generate the second video based on the template resource content and the second material; and
obtain the second video sent by the video generation device.

12. The electronic device according to claim 9, wherein the computer-executable instructions to configure the processor to determine the at least one time range corresponding to the highlight content in the first video and the second video based on the first video and the second video comprise computer-executable instructions to configure the processor to:
determine at least one first video frame in the first video that satisfies a preset filtering condition and at least one second video frame in the second video that satisfies the preset filtering condition; and
determine the at least one time range based on the at least one first video frame and the at least one second video frame.

13. The electronic device according to claim 12, wherein the computer-executable instructions to configure the processor to determine the at least one first video frame in the first video that satisfies the preset filtering condition and the at least one second video frame in the second video that satisfies the preset filtering condition comprise computer-executable instructions to configure the processor to:
perform a frame extraction operation on the first video based on a preset frame extraction parameter, to obtain a plurality of first video frames to be filtered, wherein the frame extraction parameter comprises a frame extraction frequency and a frame extraction number;
for each first video frame to be filtered, identify a plurality of dimensions of image parameters associated with the first video frames to be filtered through a preset image identification algorithm;
perform, based on a weight parameter corresponding to each dimension of image parameter, a weighting operation on the plurality of dimensions of image parameters associated with the first video frames to be filtered, to obtain a first weighting result;
determine a first video frame to be filtered with a first weighting result greater than a preset threshold as the first video frame;
and
perform a frame extraction operation on the second video based on a preset frame extraction parameter, to obtain a plurality of second video frames to be filtered, wherein the frame extraction parameter comprises a frame extraction frequency and a frame extraction number;
for each second video frame to be filtered, identify a plurality of dimensions of image parameters associated with the second video frames to be filtered through a preset image identification algorithm;
perform, based on a weight parameter corresponding to each dimension of image parameter, a weighting operation on the plurality of dimensions of image parameters associated with the second video frames to be filtered, to obtain a second weighting result; and
determine a second video frame to be filtered with a second weighting result greater than the preset threshold as the second video frame.

14. The electronic device according to claim 12, wherein the computer-executable instructions to configure the processor to determine the at least one time range based on the at least one first video frame and the at least one second video frame comprise computer-executable instructions to configure the processor to:
determine at least one first time range corresponding to the at least one first video frame, and determine at least one second time range corresponding to the at least one second video frame;
determine at least one overlapping time range overlapped among the at least one first time range and at least one second time range; and
determine the at least one overlapping time range as the at least one time range.

15. The electronic device according to claim 9, wherein the computer-executable instructions to configure the processor to determine the template quality of the preset template based on the at least one time range and the template generation protocol corresponding to the preset template comprise computer-executable instructions to configure the processor to:
for each time range, determine, from the template generation protocol, a video processing element matching with the time range;
determine whether a video processing effect corresponding to the video processing element is matched with a video effect corresponding to the time range in the second video, to obtain a processing result; and
determine the template quality corresponding to the preset template based on the processing result corresponding to the at least one time range.

16. The electronic device according to claim 15, wherein the computer-executable instructions to configure the processor to determine the template quality corresponding to the preset template based on the processing result corresponding to the at least one time range comprise the computer-executable instructions to configure the processor to:
determine a target number of time ranges within which the video processing effect corresponding to the video processing element is matched with the video effect associated with the second video;
determine a target proportion of the target number over the at least one time range; and
determine the template quality corresponding to the preset template based on the target proportion and a preset proportion threshold.

17. A non-transitory computer-readable storage medium, storing computer-executable instructions which, when executed by a processor, configure the processor to:
obtain a first video generated based on a preset template and a first material;
generate a second video based on the preset template and a second material, wherein a material complexity of the second material is less than a material complexity of the first material;
determine at least one time range corresponding to highlight content in the first video and the second video based on the first video and the second video;
determine template quality of the preset template based on the at least one time range and a template generation protocol corresponding to the preset template, the template generation protocol comprising at least one video processing element associated with the preset template and a time range associated with the at least one video processing element; and
push the preset template to a target user group in response to the template quality of the preset template satisfying a preset pushing condition.

18. The non-transitory computer-readable storage medium according to claim 17, wherein the first video comprises a content obtaining channel associated with the preset template; and
wherein the computer-executable instructions configuring the processor to generate the second video based on the preset template and the second material comprise computer-executable instructions to configure the processor to:
obtain, based on the content obtaining channel, template resource content associated with the preset template; and
generate the second video based on the template resource content and the second material.

19. The non-transitory computer-readable storage medium according to claim 18, wherein the computer-executable instructions configuring the processor to generate the second video based on the template resource content and the second material comprise computer-executable instructions to configure the processor to:
determine usage states of a plurality of preset video generation devices, wherein an usage state of the usage states comprises an idle state and an occupied state;
send the template resource content to any video generation device with the usage state being the idle state, to cause the video generation device to generate the second video based on the template resource content and the second material; and
obtain the second video sent by the video generation device.

20. The non-transitory computer-readable storage medium according to claim 17, wherein the computer-executable instructions configuring the processor to determine the at least one time range corresponding to the highlight content in the first video and the second video based on the first video and the second video comprise computer-executable instructions to configure the processor to:
determine at least one first video frame in the first video that satisfies a preset filtering condition and at least one second video frame in the second video that satisfies the preset filtering condition; and
determine the at least one time range based on the at least one first video frame and the at least one second video frame.
